(19) United States
(12) Patent Application Publication
(10) Pub. No.: US 2022/0327240 A1
(43) Pub. Date: Oct. 13, 2022

(54) METHOD FOR SECURING ASSET MAINTENANCE INFORMATION AND ASSET HAVING A LIFECYCLE BLOCKCHAIN NODE

(71) Applicant: Siemens Aktiengesellschaft, München (DE)

(72) Inventors: Christian Deeg, Altdorf (DE); Matthias Manger, Fürth (DE); Bernd Wacker, Herzogenaurach (DE)

(73) Assignee: Siemens Aktiengesellschaft, München (DE)

(21) Appl. No.: 17/717,893

(22) Filed: Apr. 11, 2022

(30) Foreign Application Priority Data
Apr. 12, 2021 (EP) 21167876.8

(51) Int. Cl. G06F 21/64

(52) U.S. Cl. CPC G06F 21/64

(57) ABSTRACT

In a method for securing asset maintenance information, genesis transaction data is generated as a function of manufacturer-specific asset data. A distributed ledger technology (DLT) data structure is generated on the basis of the genesis transaction data. In response to a lifecycle activity relating to the asset, during which maintenance-related asset data is produced, transaction data is generated on the basis of the maintenance-related asset data produced during the lifecycle activity and is added to the DLT data structure. The DLT data structure is distributed to at least one DLT node in order to secure the maintenance-related asset data.

### CROSS-REFERENCES TO RELATED APPLICATIONS

This application claims the priority of European Patent Application, Serial No. 21167876.8, filed Apr. 12, 2021, pursuant to 35 U.S.C. 119(a)-(d), the disclosure of which is incorporated herein by reference in its entirety as if fully set forth herein.

### BACKGROUND OF THE INVENTION

The present invention relates to a method for securing asset maintenance information and to an asset, e.g. an industrial asset or an asset of an industrial plant, having a lifecycle blockchain node.

The following discussion of related art is provided to assist the reader in understanding the advantages of the invention, and is not to be construed as an admission that this related art is prior art to this invention.

Non-conformance costs (additional costs) are often created over the lifecycle due to improper maintenance, installation of incorrect spare parts or as a result of modification/conversion. Following supply from the factory/sale from the factory of manufacture, it is often impossible to retrace who carried out what action on the product, and when.

It is not unusual for industrial products to be sold, resold, recycled by means of acquisition and sold as second-hand. The lifecycle of an electric motor may be 25-40 years, for example. PCs or other devices with data media normally have a significantly shorter service life. Documentation relating to maintenance or modifications during the lifecycle are incomplete, fragmented or missing.

Industrial products that are subject to wear, e.g. motors, transmissions, etc., have relatively long product lifecycles during which numerous routine or non-routine maintenance tasks and modifications are required. It is often the case with these products that after a number of years there is little or no transparency concerning whether maintenance tasks have been performed at the required intervals or using the authorized spare parts or by qualified personnel. This often results in shorter lifecycles due to improper maintenance, replacement or repair (too often, not often enough, use of incorrect consumable materials, incorrect or unavailable measuring methods, etc.). In the event of failures, it is then often a matter of onerous resolution with the manufacturers regarding assumption of costs, concession of warranty/guarantee, and then protracted transportation of returned goods and evaluations.

Repair timescales often last longer than necessary. Environmental protection concepts such as second-life programs exacerbate this problem.

The documentation of maintenance, modification, etc. is nowadays performed by the relevant contracted firm or by the Original Equipment Manufacturer (mechanical engineer) and usually takes place on local PCs, servers with suitable software (e.g. asset management systems) or even on paper.

It would be desirable and advantageous to obviate prior art shortcomings and to provide improved documentation relating to maintenance or modifications during the lifecycle.

### SUMMARY OF THE INVENTION

According to one aspect of the invention, a method for securing asset maintenance information of an asset incudes generating genesis transaction data as a function of manufacturer-specific asset data, generating a DLT (Distributed Ledger Technology) data structure based on the genesis transaction data, producing maintenance-related asset data during a lifecycle activity relating to the asset, generating transaction data in response to the lifecycle activity based on the maintenance-related asset data produced during the lifecycle activity, adding the transaction data to the DLT data structure, distributing the DLT data structure to at least one DLT node, and securing the maintenance-related asset data.

According to another advantageous feature of the invention, only the maintenance-related data can be produced during the lifecycle activity relating to the asset. In the context of the invention, the term “lifecycle activity of an asset” is understood to relate e.g. to project planning, engineering, manufacturing, operation, servicing and maintenance, procurement of spare parts and scrapping.

According to another advantageous feature of the invention, provision can be made for the updated DLT data structure to be distributed after each lifecycle activity. This allows OEMs (OEM: Original Equipment Manufacturer), service providers and maintenance contractors to document in a retraceable and unforgeable manner authorized spare parts and consumable materials that have been used, reliably and for every maintenance task/modification that has been performed in a retraceable manner.

The manufacturer-specific asset data must have a unique instance as its basic content. Instance data must contain an individual data reference (“finger-print”) which identifies it with name and origin. Instance data must include the serial number (name) and additionally e.g. manufacturer “X”, device factory “Y”, certificate “ABC”, etc. and/or device MAC address and/or device IP address and/or machine-readable model identifier (static) and/or Manufacturer Device Certificate (MDC) (static) and/or one or more public and private keys and/or OEM-specific data and/or integrator-specific data and/or data specific to a customer site or subsidiary customer site (e.g. Customer Device Certificate: CDC) and/or Project-related Device Certificate (PDC) or (if the device is used in multiple projects) a plurality of such certificates (dynamic) and/or further information relating to technical and mechanical features such as the performance and the supported communication and/or application protocols (static and/or dynamic).

A DLT node can comprise a machine-readable memory, e.g. volatile or non-volatile memory, on which machine-executable components can be stored, and a processor which is operatively coupled to the machine-readable memory and is configured to execute the machine-executable components.

According to another advantageous feature of the invention, provision can be made for the DLT to be a blockchain. Other data structures based on DLT are also possible, e.g. DAG (Directed Acrylic Graph), Ethereum, Hyperledger Fabric, etc.

According to another advantageous feature of the invention, provision can be made for the blockchain to be private and/or permissioned.

According to another advantageous feature of the invention, provision can be made for the blockchain to be private and permissionless. This can be advantageous for auditing purposes in particular.

According to another advantageous feature of the invention, provision can be made for a supply factory of the asset to have a DLT node and a digital copy of the asset (the so-called digital twin), or to be linked to its instance on the digital twin.

A digital twin of an asset can be, e.g., a digital copy of the physically existing asset, containing data and information about its type and its operating characteristics and data relating to its (possibly entire) time axis, which data and information is exchanged among users/tools and can be configured in one or more virtual geometric, physical (mechanical, electrical, thermal, work carried out, applied force/torque, state changes such as vibration, magnetic field, temperature) or chemical copies. This has the advantage that a digital “check book” based on the use of DLT is available as part of the digital twin of industrial products. It is therefore possible in a consistent and unforgeable manner to document required lifecycle information relating to the operational product/asset.

According to another advantageous feature of the invention, provision can be made for maintenance-related asset data to include information concerning maintenance tasks and/or modifications that have been performed and/or spare parts and/or consumable materials that have been used.

According to another advantageous feature of the invention, provision can be made for the transaction data to be digitally signed by an entity which brings about the lifecycle activity. It is therefore possible for the required lifecycle information relating to the operational product/asset to be labeled in a consistent manner by the digital signatory.

The labels that are used can ensure the legitimacy of the person/firm that performed the job content. Labels used include e.g. “Delivery status OEM, modification by OEM or certified partner or service provider of the OEM, plant operator”. Or possibly also “Use of OEM spare parts, OEM-approved equivalent spare part or consumable material, third-party material, etc.”.

According to another advantageous feature of the invention, provision can be made for the asset to be an electrical rotatory machine, e.g. a motor, a drive, a drive with a motor, a machine, e.g. a machine tool, in particular a milling machine, a plant, in particular an industrial plant.

According to another advantageous feature of the invention, provision can be made for the manufacturer-specific asset data to be stored on or in the asset in a hardware-linked manner. For example, the manufacturer-specific asset data can be stored in a non-rewritable data memory of an in-metal RFID which is arranged on or in the asset, this having the particular advantage that at least the instance data is preserved therein over the entire lifecycle unless it is mechanically and irreversibly destroyed. In addition, the manufacturer-specific asset data can be stored e.g. in a so-called hardware secure element which is integrated in the basic hardware, e.g. a TPM (Trusted Platform Module) or HSM (Hardware Security Module).

According to another aspect of the invention, an asset includes manufacturer-specific asset data and a DLT (Distributed Ledger Technology) node, wherein the DLT node is configured to generate genesis transaction data as a function of manufacturer-specific asset data, to generate a DLT data structure based on the genesis transaction data, to produce maintenance-related asset data during a lifecycle activity relating to the asset, to generate transaction data in response to the lifecycle activity based on the maintenance-related asset data produced during the lifecycle activity, to add the transaction data to the DLT data structure, to distribute the DLT data structure to at least one DLT node; and to secure the maintenance-related asset data.

According to another advantageous feature of the invention, provision can be made for the manufacturer-specific asset data to be stored in the asset in a hardware-linked manner. For example, the manufacturer-specific asset data, e.g. a serial number, can be stored in a read-only memory which cannot be changed and is embedded in the asset. For example, the manufacturer-specific asset data can be stored in a non-rewritable data memory of an in-metal RFID which is arranged on or in the asset. The manufacturer-specific asset data, e.g. the serial number of the product, can also be incorporated in the product as e.g. a hash value, and specifically in such a way that it can only be removed by means of destruction.

According to another advantageous feature of the invention, provision can be made for the DLT to be a blockchain.

According to another advantageous feature of the invention, provision can be made for the blockchain to be private and/or permissioned.

According to another advantageous feature of the invention, provision can be made for maintenance-related asset data to include information concerning maintenance tasks and/or modifications that have been performed and/or spare parts and/or consumable materials that have been used.

According to another advantageous feature of the invention, provision can be made for the transaction data to be digitally signed by an entity which brings about the lifecycle activity.

According to another advantageous feature of the invention, provision can be made for the asset to be a motor, a drive, a drive with a motor, a machine or a plant.

In accordance with the invention, a DLT data structure is disclosed which is associated with the asset during manufacture and is maintained, extended and/or updated during the lifecycle until scrapping. The storage can take place locally on the asset and in the participating nodes. The respectively current version can be stored as a copy in the digital twin of the OEM and on further nodes which participated previously. The verification/confirmation of DLT legitimacy can be effected e.g. through correlation with the authorized decentralized systems (cloud, edge, etc.) participating in the modification, followed by transfer to the local asset memory. Advantageous in this case is an absence of dependency on a local server solution that has to be capable of authorization and user management over a plurality of decades. In addition, unforgeable and legitimized documentation of modification, maintenance and servicing tasks can be provided in the digital twin as a result of using blockchain technology and storage in the digital product twin of the manufacturer over the entire product lifecycle. Furthermore, decisions relating to warranty and guarantee can be accelerated. As a result, the overall handling of industrial equipment faults can be simplified and also performed more quickly.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 shows an Information Technology (IT) infrastructure for securing asset maintenance information of an asset, and

FIG. 2 shows a flow diagram of a method for securing asset maintenance information of an asset.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

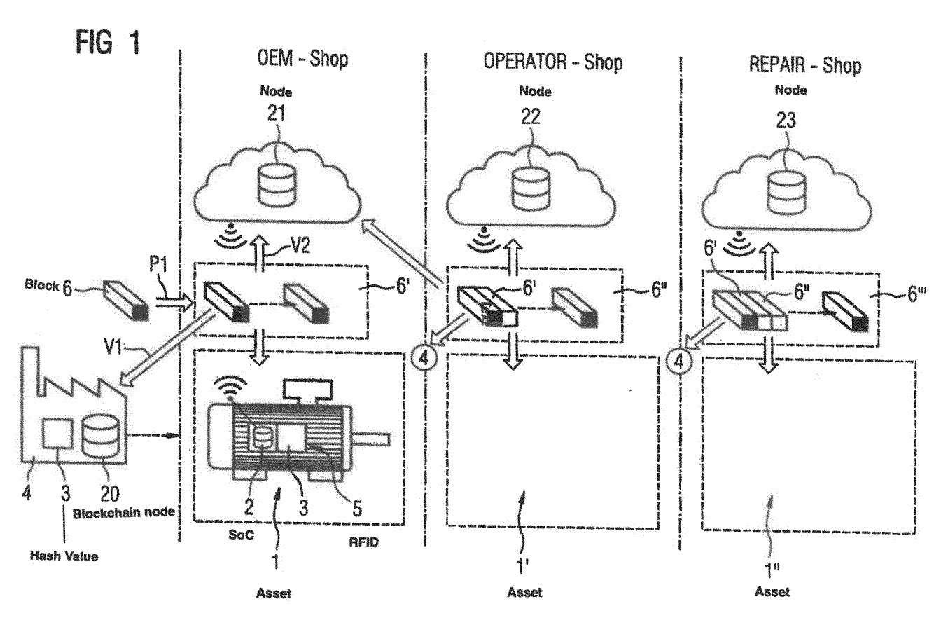

Turning now to the drawings, and in particular to FIG. 1, there is shown an IT infrastructure for securing asset maintenance information of an asset. An asset, which by way of example here takes the form of a motor 1, e.g. an asynchronous motor, has a blockchain node which here takes the form of a System-on-a-Chip (SoC) 2. The motor 1 also comprises manufacturer-specific asset data which is present here by way of example in the form of a hash value 3 of a motor identifier, e.g. a serial number of the motor 1, which the motor 1 was assigned during manufacture in a manufacturing plant 4.

As is readily apparent from FIG. 1, the hash value 3 does not have to be stored on the SoC 2. The hash value 3 can be stored on a device which is designed to be structurally separate from the SoC 2.

The hash value 3 can advantageously be stored in the motor 1 in a hardware-linked manner. For example, the hash value 3 can be stored in a non-rewritable data memory of an in-metal RFID 5. For example, the in-metal RFID 5 can be arranged on or in the motor 1 in such a way that it can only be removed by the destruction thereof (of the in-metal RFID) and consequently destruction of the hash value 3. For example, the in-metal RFID 5 can be incorporated in a female part e.g. the motor housing which contains the stator of the motor 1. This can be achieved e.g. by means of a countersunk hole in the motor housing, into which the in-metal RFID 5 can be cemented in a non-removable manner.

The blockchain node 2 can comprise a machine-readable memory, e.g. volatile or non-volatile memory, on which machine-executable components can be stored, and a processor which is operatively coupled to the machine-readable memory and is configured to execute the machine-executable components.

In addition, the System-on-a-Chip (SoC) 2 can comprise a communication device which can be e.g. configured to communicate with the in-metal RFID 5 and read out the hash value 3. For this purpose, the communication device can comprise e.g. a near-field communication (NFC) chip. It can be appropriate in this case for the SoC 2 to be within radio range of the in-metal RFID chip 5.

Moreover, it can be appropriate for the blockchain node 2 to be equipped with a communication modem. The communication device can generally be designed to communicate using a specific (e.g. wireless) type of communication: mobile radio networks (e.g. 4G, 5G), Bluetooth, WiFi, LAN, bus, LPWAN standards, etc.

Using the hash value 3, the blockchain node 2 in the form of a SoC can generate genesis transaction data and, on the basis of the genesis transaction data, can create the first block of the blockchain—the so-called genesis block 6.

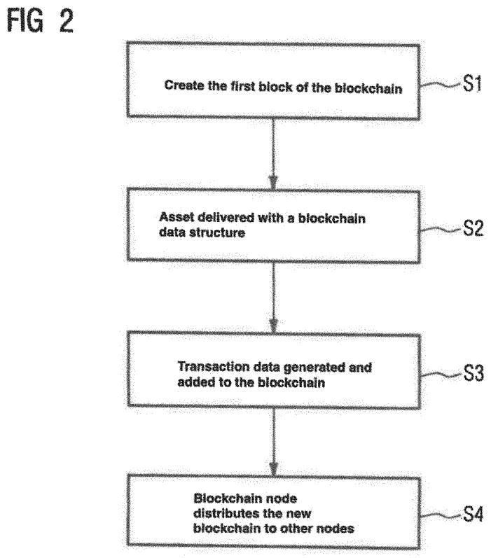

This can take place in the context of steps S1 and S2 of the method illustrated in FIG. 2. Steps S1 and S2 can already take place e.g. In the manufacturing hall 4 of the manufacturer of the motor 1, so that the motor 1 can already be delivered (arrow P1) with a blockchain data structure (with the genesis block 6) to the OEM shop floor (production hall of the Original Equipment Manufacturer).

It can be appropriate for both the manufacturing hall or supply factory 4 and the Original Equipment Manufacturer each to have a blockchain node—manufacturer blockchain node 20 and OEM blockchain node 21—and participate in the blockchain associated with the motor 1.

If the Original Equipment Manufacturer performs a modification immediately upon commissioning the motor 1, data is produced which relates to the motor and is therefore inherent in its maintenance: maintenance-related motor data.

On the basis of the maintenance-related motor data that is produced during this lifecycle activity, transaction data can be generated and added to the blockchain in step S3.

The generation of the transaction data and addition of this transaction data to the blockchain (blockchain extension), a block 6′ being generated first in a manner that is known from the prior art, can be effected e.g. by the SoC 2. The motor with the extended blockchain blocks 6 and 6′ is the motor 1′.

The motor data and/or the transaction data can optionally be digitally signed by the OEM.

Provision can be made such that the OEM blockchain node 21 is first required to provide authorization before supplying the maintenance-related motor data to the SoC 2. Cryptographic methods can be used for this purpose, e.g. asymmetric encryption systems. For example, provision can be made such that each blockchain node of the blockchain is required to have a key in order to be able to participate in the blockchain.

Moreover, provision can be made for the blockchain node 2 to confer with the in-metal RFID 5 in order to compare the hash value 3 with a hash value in the genesis block 6. This can function as a condition for updating the blockchain: if the values correspond, the blockchain can be updated.

In step S4 following thereupon, the blockchain node 2 can distribute the new blockchain (the updated blockchain data structure, the ledger) to other nodes 20, 21 (arrows V1, V2).

As a result of the manufacturer blockchain node 20 participating in the blockchain, the advantage is derived that e.g. a digital twin of the motor 1 can also be documented in an unforgeable and authorized manner.

The blockchain can be a private blockchain. It can additionally or instead be permissioned. For auditing purposes, it can be appropriate for the blockchain to be private and permissionless.

During the service life of the motor 1, further blockchain nodes such as e.g. operator node 22, repair shop node 23, insurance node (not shown) can also be added.

The lifecycle activities during which further blocks 6″, 6′″ are added to the motor blockchain in a similar manner can include maintenance tasks, repair tasks, further modification tasks such as e.g. upgrades etc., and change the state of the motor as a result, the changes being stored in the blockchain of the motor (motor 1′ with blocks 6, 6′, motor 1″ with blocks 6, 6′, 6″, etc.).

Following each blockchain extension, a copy of the current blockchain is sent to all participating nodes (shown by arrows in FIG. 1).

The maintenance-related motor data can include information concerning maintenance tasks and/or modifications that have been performed and/or spare parts and/or consumable materials that have been used.

It should be emphasized at this point that the OEM can start its own blockchain based on the genesis block 6, without the supply factory 4 having to participate in this.

In summary, the present disclosure relates to industrial assets that are equipped with a blockchain in which information relating to the asset lifecycle serves as a distributed ledger, and to the method for blockchain generation.

Although FIG. 1 shows only a single field device, an actuator in the form of a motor 1 in this case, a person skilled in the art can infer from the present technical teaching that any motor in a plant can have a blockchain node which participates in a blockchain that is provided for the purpose of monitoring the lifecycle activities relating to the motor. Each motor can be assigned a respective blockchain data structure, different motors participating in different blockchains.

Furthermore, the asset can take the form of an electrical rotatory machine, a field device, an actuator, a drive, a drive with a motor, a machine, e.g. a machine tool, in particular a milling machine, a plant, e.g. a manufacturing plant or an industrial plant.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated. In particular, the features described in connection with the method can also be applied or added to the relevant system or asset and vice versa.

What is claimed as new and desired to be protected by Letters Patent is set forth in the appended claims and includes equivalents of the elements recited therein:

What is claimed is:

1. A method for securing asset maintenance information of an asset, said method comprising:
generating genesis transaction data as a function of manufacturer-specific asset data;
generating a DLT (Distributed Ledger Technology) data structure based on the genesis transaction data;
producing maintenance-related asset data during a lifecycle activity relating to the asset;
generating transaction data in response to the lifecycle activity based on the maintenance-related asset data produced during the lifecycle activity;
adding the transaction data to the DLT data structure;
distributing the DLT data structure to at least one DLT node; and
securing the maintenance-related asset data.

2. The method of claim 1, wherein the DLT data structure is a blockchain.

3. The method of claim 2, wherein the blockchain is private and/or permissioned.

4. The method of claim 1, wherein the maintenance-related asset data comprises information concerning maintenance tasks and/or modifications that have been performed and/or spare parts and/or consumable materials that have been used.

5. The method of claim 1, further comprising digitally signing the transaction data by an entity which brings about the lifecycle activity.

6. The method of claim 1, wherein the asset is an electrical rotatory machine, a motor, a drive, a drive with a motor, a machine, a machine tool, a milling machine, a plant, or an industrial plant.

7. The method of claim 1, further comprising storing the manufacturer-specific asset data on or in the asset in a hardware-linked manner.

8. An asset, comprising:
manufacturer-specific asset data; and
a DLT (Distributed Ledger Technology) node configured
to generate genesis transaction data as a function of the manufacturer-specific asset data,
to generate a DLT data structure based on the genesis transaction data,
to produce maintenance-related asset data during a lifecycle activity relating to the asset,
to generate transaction data in response to the lifecycle activity based on the maintenance-related asset data produced during the lifecycle activity,
to add the transaction data to the DLT data structure,
to distribute the DLT data structure to at least one DLT node, and
to secure the maintenance-related asset data.

9. The asset of claim 8, wherein the manufacturer-specific asset data is stored in the asset in a hardware-linked manner.

10. The asset of claim 8, wherein the DLT is a blockchain.

11. The asset of claim 10, wherein the blockchain is private and/or permissioned.

12. The asset of claim 8, wherein the maintenance-related asset data comprises information concerning maintenance tasks and/or modifications that have been performed and/or spare parts and/or consumable materials that have been used.

13. The asset of claim 8, wherein the transaction data is digitally signed by an entity which brings about the lifecycle activity.

14. The asset of claim 8, wherein the asset is a field device, an actuator, a motor, a drive, a drive with a motor, a machine or a plant.

15. A machine-executable component stored on a memory, said machine-executable component, when executed by a processor of a DLT (Distributed Ledger Technology) node operatively coupled to the memory, causes the DLT node to perform a method as set forth in claim 1.
